(19) United States
(12) Patent Application Publication
(10) Pub. No.: US 2011/0221558 A1
(43) Pub. Date: Sep. 15, 2011

(54) COIL OF A TRANSFORMER

(75) Inventors: Kuo-Chu YEH, New Taipei City (TW); Shu-Wei Yeh, New Taipei City (TW); Chun-Chieh Chu, New Taipei City (TW); Wei-Liang Lin, New Taipei City (TW)

(73) Assignee: ACBEL POLYTECH INC., New Taipei City (TW)

(21) Appl. No.: 13/034,838

(22) Filed: Feb. 25, 2011

(30) Foreign Application Priority Data
Mar. 11, 2010 (TW) 099107024

(51) Int. Cl. H01F 27/29

(52) U.S. Cl. 336/192

(57) ABSTRACT

A coil of a transformer has two side conducting brackets and at least one middle conducting bracket. The middle conducting bracket is elongated or spiral-shaped and has two terminals respectively connected to the side conducting brackets. The side conducting brackets and the at least one middle conducting bracket of some specific type are connected to form different numbers of loops or different types of circuits (series circuits or parallel circuits). Therefore, design and fabrication of the coil is flexible and materials and manufacturing costs are saved. Moreover, the side conducting brackets and the at least one middle conducting bracket require only two or four soldered joints so number of soldered joints required is limited and efficiency of the transformer is improved.

### BACKGROUND OF THE INVENTION

1. Field of the Invention

The present invention relates to a transformer, especially to a transformer coil that is fabricated using specific conducting brackets to forms different coils.

2. Description of the Prior Art(s)

Large-scale electronic equipment has a power supply with a rectifier and a transformer. The rectifier rectifies alternating current (AC) to direct current (DC). The transformer has a core, and a primary winding and a secondary winding wound around the core and transforms the DC to lower voltage, higher current to provide sufficient power to electronic components in large scale electronic equipment. A conventional method to fabricate the secondary winding is to wind an enamel wire around the core. However, a diameter of the conventional enamel wire is too small to allow high current to flow through. Moreover, the secondary winding fabricated by winding is difficult to dissipate heat and has high impedance and power loss.

According to the above mentioned shortcomings, a flat and continuous conductive strip is proposed to reduce impedance, increase heat dissipating area and lower energy waste of the secondary winding of the transformer.

With reference to FIG. 11, a conventional transformer has a coil (41), an upper core (42) and a lower core (43). The coil (41) is a continuous strip and may be a primary winding or a secondary winding of the conventional transformer. A method to form the coil (41) of the conventional transformer is to apply a stamping process to a flat conductive plate so the conductive plate becomes a continuous strip. Then folding the flat and continuous strip to form a winding. As shown in FIG. 11, the coil (41) of the conventional transformer forms a parallel circuit and has one loop.

However, since a stamping mold forms one kind of coil (41), when different numbers of loops or different types of circuits (series circuits or parallel circuits) are needed, the coil (41) is redesigned. When the coil (41) does not meet requirements for numbers of loops or connection method, the stamping mold becomes invalid. Therefore, design of the conventional coil (41) is inflexible and requires high manufacturing costs.

With further reference to FIG. 12, another conventional transformer has multiple stacked annular winding patterns (51). The stacked winding patterns (51) may be a primary winding or a secondary winding of the conventional transformer. Each winding pattern (51) has two mounting holes (511) formed through two ends of the winding pattern (51). Multiple pins (52) are respectively mounted through the mounting holes (511) of the winding patterns (51) to connect the winding patterns (51) to form a series or parallel circuit and are electrically connected to a circuit board.

The conventional transformer needs only several different kinds of winding patterns (51) to meet requirements for number of loops or connection method. However, multiple soldered joints are formed between each winding pattern (51) and each pin (52). Increasing number of soldered joints and current flow increases impedance and power loss (P=I*I*R). To reduce the impedance, cross-sectional areas of the pins (52) should be enlarged. Nevertheless, widths of the ends of the winding patterns (51) limit the cross-sectional areas of the pins (52). Therefore, the power loss of the conventional transformer is still not efficiently solved.

To overcome the shortcomings, the present invention provides a coil of a transformer to mitigate or obviate the aforementioned problems.

### SUMMARY OF THE INVENTION

The main objective of the present invention is to provide a coil of a transformer. The coil has two side conducting brackets and at least one middle conducting bracket. The middle conducting bracket is elongated or spiral-shaped and has two terminals respectively connected to the side conducting brackets.

The side conducting brackets and the at least one middle conducting bracket of some specific type are connected to form different numbers of loops or different types of circuits (series circuits or parallel circuits). Therefore, design and fabrication of the coil is flexible and materials and manufacturing costs are saved.

Moreover, the side conducting brackets and the at least one middle conducting bracket require only two soldered joints when connected to form a series circuit or four soldered joints when connected to form a parallel circuit. Thus, number of the soldered joints required is limited so efficiency of the transformer is improved.

Other objectives, advantages and novel features of the invention will become more apparent from the following detailed description when taken in conjunction with the accompanying drawings.

### BRIEF DESCRIPTION OF THE DRAWINGS

FIG. 1 is an exploded perspective view of a first embodiment of a coil of an electromagnetic component in accordance with the present invention, shown forming a series circuit;

FIG. 2 is a perspective view of the coil in FIG. 1, shown forming the series circuit;

FIG. 3 is another exploded perspective view of the coil in FIG. 1, shown forming a parallel circuit;

FIG. 4 is a perspective view of the coil in FIG. 3, shown forming the parallel circuit;

FIG. 5 is an exploded perspective view of a second embodiment of a coil of an electromagnetic component in accordance with the present invention, shown forming a parallel circuit;

FIG. 6 is a perspective view of the coil in FIG. 5, shown forming the parallel circuit;

FIG. 7 is another perspective view of the coil in FIG. 5, shown forming the parallel circuit;

FIG. 8 is an exploded perspective view of a third embodiment of a coil of an electromagnetic component in accordance with the present invention, shown forming a series circuit;

FIG. 9 is a perspective view of the coil in FIG. 8, shown forming the series circuit;

FIG. 10 is another perspective view of the coil in FIG. 8, shown forming the series circuit;

FIG. 11 is an exploded perspective view of a conventional coil of an electromagnetic component in accordance with the prior art; and

FIG. 12 is a perspective view of another conventional coil of an electromagnetic component in accordance with the prior art.

### DETAILED DESCRIPTION OF THE PREFERRED EMBODIMENTS

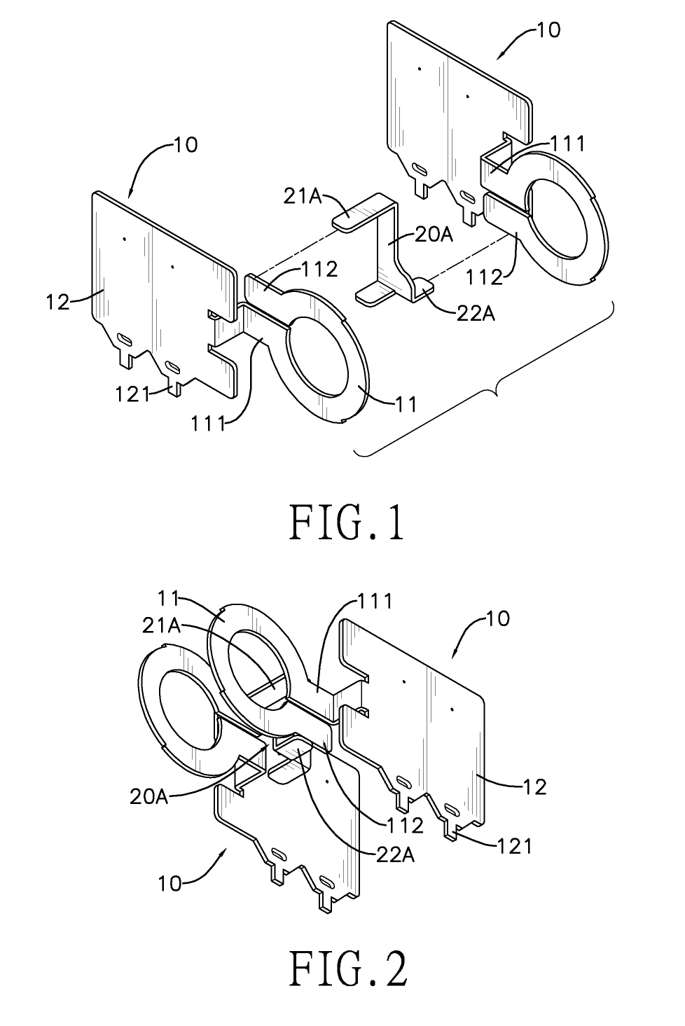

With reference to FIGS. 1 and 2, a coil of a transformer in accordance with the present invention comprises two side conducting brackets (10) and at least one middle conducting bracket (20A, 20B, 20C).

The side conducting brackets (10) are disposed opposite to each other. Each side conducting brackets (10) has a ring (11) and a base panel (12).

The ring (11) of the side conducting bracket (10) has two ends, an opening, a first terminal (111) and a second terminal (112). The opening of the ring (11) of the side conducting bracket (10) is defined between the ends of the ring (11) of the side conducting bracket (10). The first and second terminals (111, 112) of the ring (11) of the side conducting bracket (10) are respectively extended outwardly from the ends of the ring (11) of the side conducting bracket (10). The first terminal (111) of one side conducting bracket (10) aligns with the second terminal (112) of the other side conducting bracket (10).

The base panel (12) is further extended from the first terminal (111) of the ring (11) of the side conducting bracket (10) and has at least one pin (121). The at least one pin (121) is formed on a peripheral edge of the base panel (12) and is soldered to a circuit board so the transformer is electrically connected to a circuit of the circuit board.

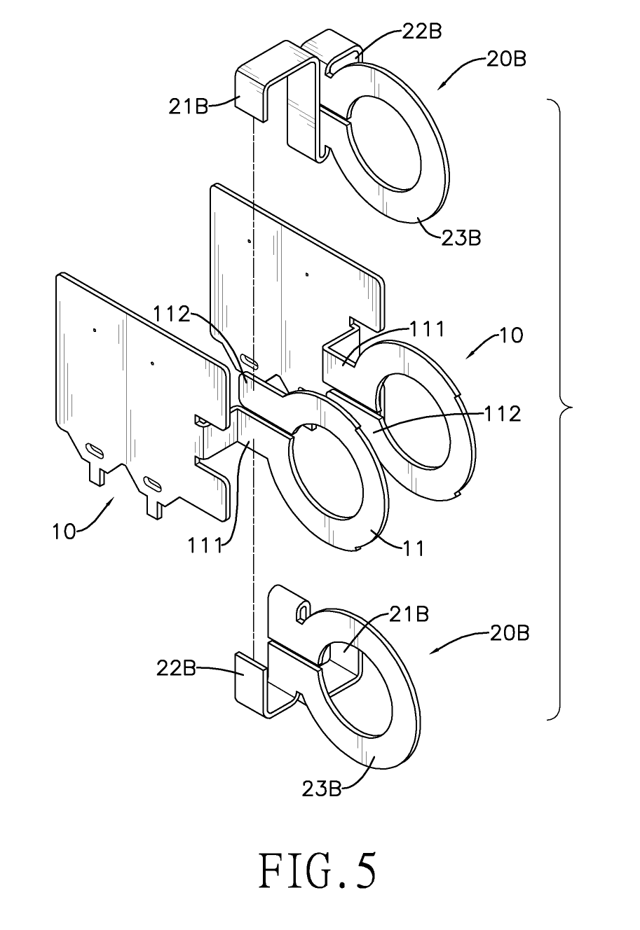

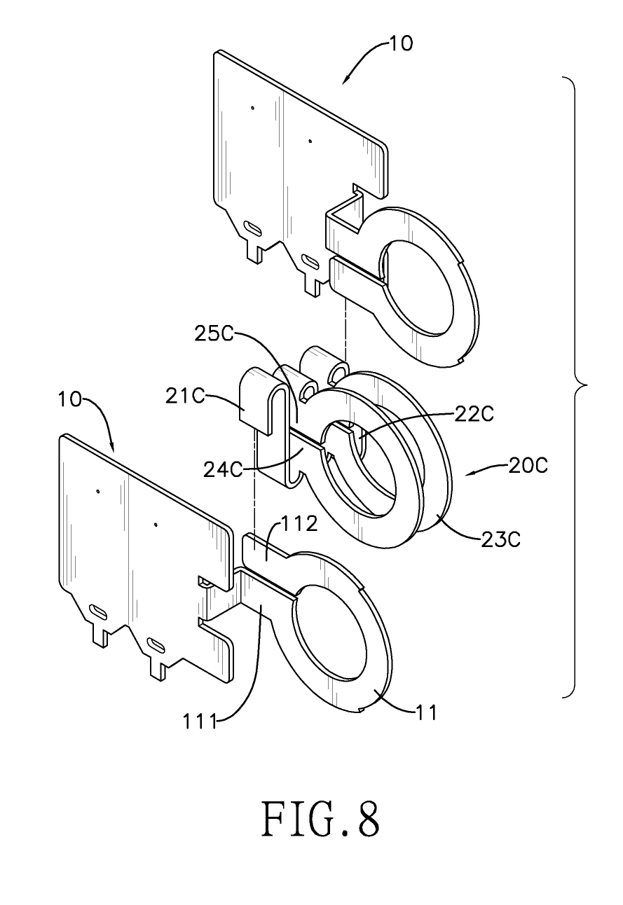

With further reference to FIGS. 5 and 8, the at least one middle conducting bracket (20A, 20B, 20C) is disposed between the side conducting brackets (10). Each of the at least one middle conducting bracket (20A, 20B, 20C) has a first terminal (21A, 21B, 21C) and a second terminal (22A, 22B, 22C) respectively connected to the first and second terminals (111, 112) of the side conducting brackets (10).

With further reference to FIGS. 1, 2 and 8 to 10, the coil may have one middle conducting bracket (20A, 20C) disposed between the side conducting brackets (10). The first and second terminals (21A, 21C, 22A, 22C) of the middle conducting bracket (20A, 20C) are respectively connected to the second terminals (112) of the side conducting brackets (10). Thus, the side and middle conducting brackets (10, 20A, 20C) are connected to form a series circuit.

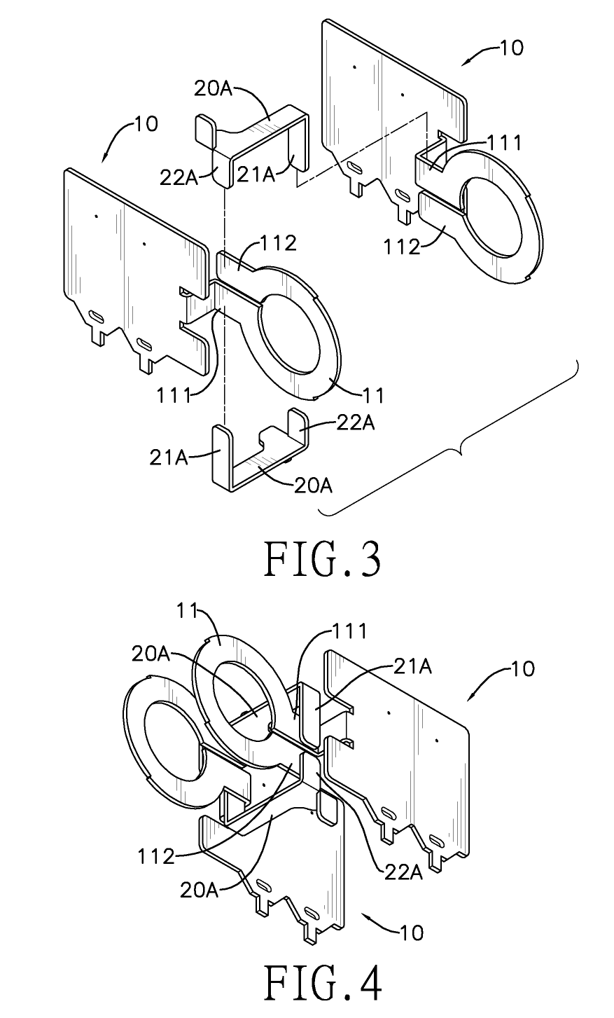

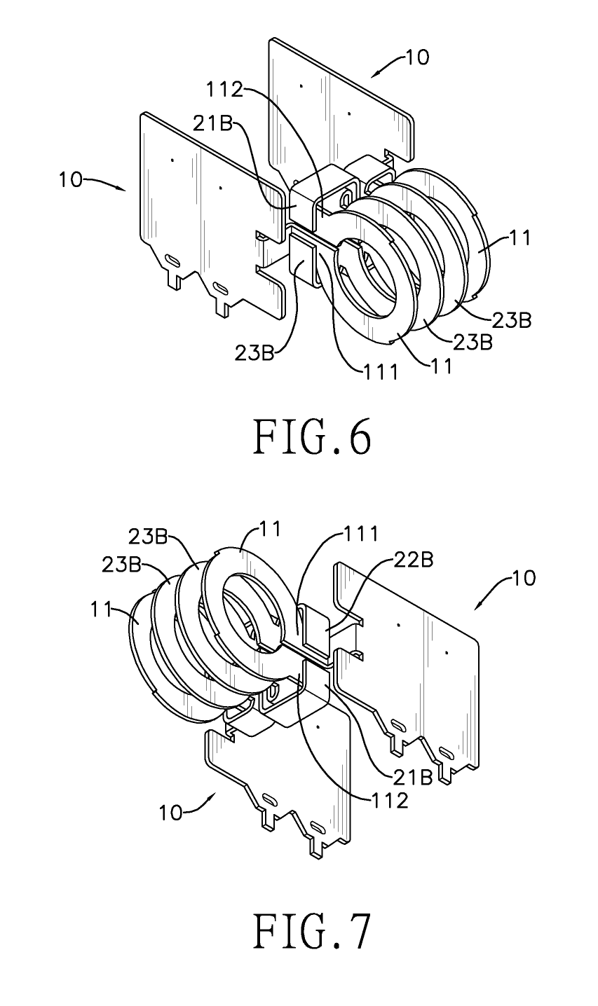

With further reference to FIGS. 3 to 7, the coil may have two middle conducting brackets (20A, 20B) disposed between the side conducting brackets (10). The first terminals (21A, 21B) of the middle conducting brackets (20A, 20B) are respectively connected to the first terminals (111) of the side conducting brackets (10). The second terminals (22A, 22B) of the middle conducting brackets (20A, 20B) are respectively connected to the second terminals (112) of the side conducting brackets (10). Thus, the side and middle conducting brackets (10, 20A, 20B) are connected to form a parallel circuit.

With reference to FIGS. 1 and 2, in a preferred embodiment, each of the at least one middle conducting bracket (20A) is elongated and has two ends. The first terminal (21A) of each of the at least one middle conducting bracket (20A) is formed on one end of the at least one middle conducting bracket (20A) and protrudes toward one side of the at least one middle conducting bracket (20A). The second terminal (22A) of each of the at least one middle conducting bracket (20A) is formed on the other end of the at least one middle conducting bracket (20A) and protrudes toward two opposite sides of the at least one middle conducting bracket (20A).

When one middle conducting bracket (20A) is disposed between the side conducting brackets (10) and is connected to the side conducting brackets (10) to form a series circuit, the coil has two loops.

With reference to FIGS. 3 and 4, when two middle conducting brackets (20A) are oppositely disposed between the side conducting brackets (10) and are connected to the side conducting brackets (10) to form a parallel circuit, the coil has only one loop.

With reference to FIGS. 5 to 10, in another preferred embodiment, each of the at least one middle conducting bracket (20B, 20C) is spiral-shaped and has at least one ring (23B, 23C). Each of the at least one ring (23B, 23C) has two ends. The first and second terminals (21B, 21C, 22B, 22C) of each of the at least one middle conducting bracket (20B, 20C) are respectively formed on protrude from the ends of the at least one ring (23B, 23C) of the at least one middle bracket (20B, 20C).

With reference to FIGS. 5 to 7, each of the at least one middle conducting bracket (20B) may have one ring (23B). The ring (23B) of each of the at least one middle conducting bracket (20B) has an opening defined between the ends of the ring (23B) of the at least one middle conducting bracket (20B). The first and second terminals (21B, 22B) of each of the at least one middle conducting bracket (20B) are respectively formed on and protrude from the ends of the ring (23B) of the at least one middle bracket (20B).

When two middle conducting brackets (20B) are oppositely disposed between the side conducting brackets (10) and are connected to the side conducting brackets (10) to form a parallel circuit, the coil has two loops.

With reference to FIG. 8, each of the at least one middle conducting bracket (20C) may have multiple rings (23C). Each ring (23C) of each of the at least one middle conducting bracket (20C) has an opening, a first extension (24C) and a second extension (25C). The opening of the ring (23C) of the at least one middle conducting bracket (20C) is defined between the ends of the ring (23C) of the at least one middle conducting bracket (20C). The second extension (25C) of the ring (23C) of the at least one middle conducting bracket (20C) is attached to the first extension (24C) of an adjacent ring (23C) of the at least one middle conducting bracket (20C). The first terminal (21C) of each of the at least one middle conducting bracket (20C) is formed on and protrudes from the first extension (24C) of the ring (23C) that is arranged in an end of the at least one middle conducting bracket (20C). The second terminal (22C) of each of the at least one middle conducting bracket (20C) is formed on and protrudes from the second extension (25C) of the ring (23C) that is arranged in another end of the at least one middle conducting bracket (20C).

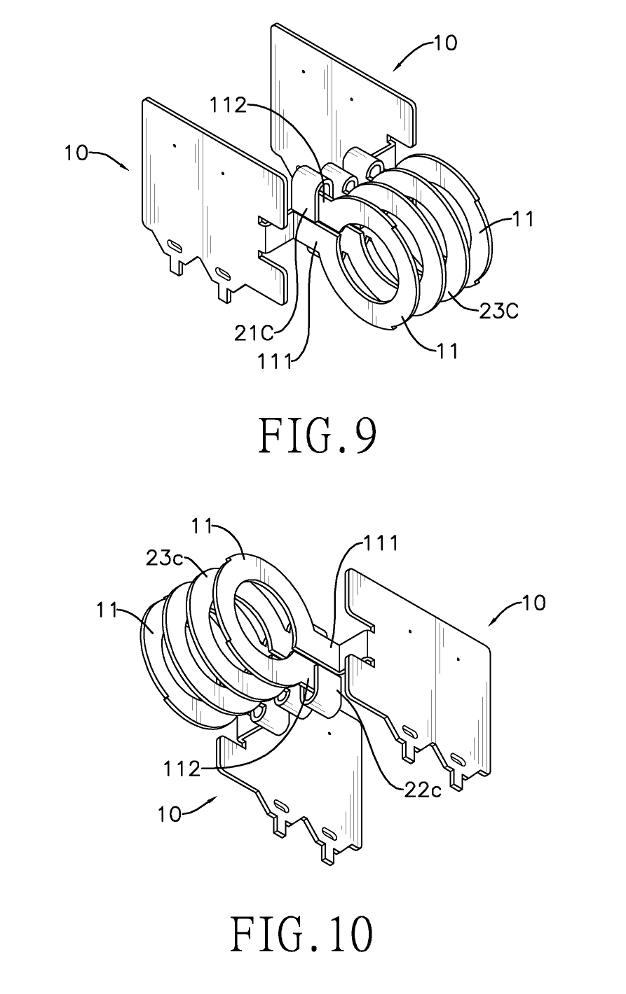

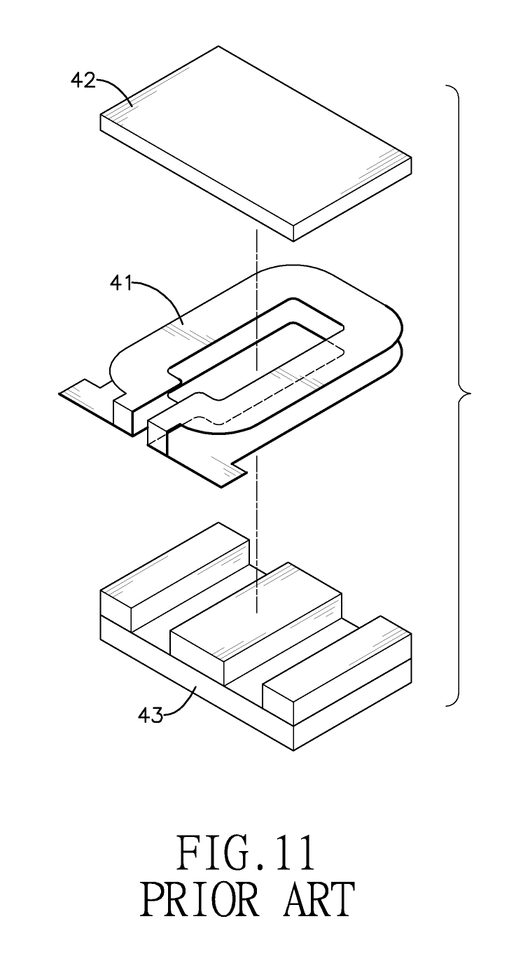

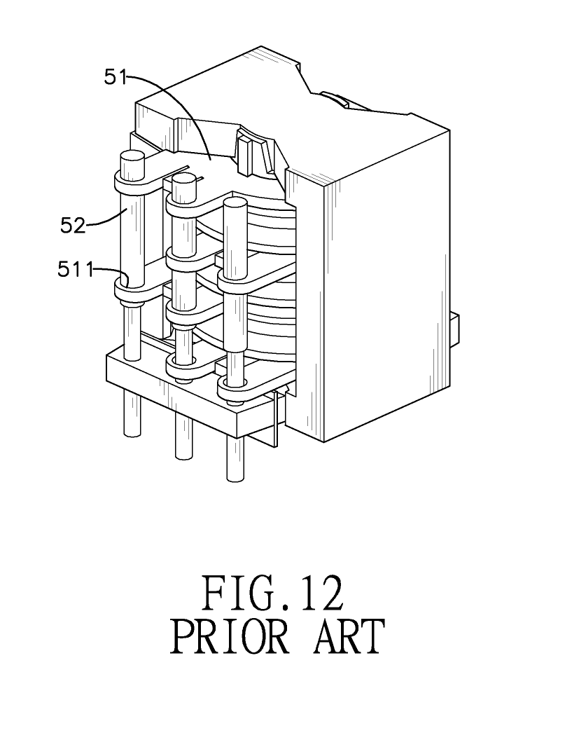

With further reference to FIGS. 9 and 10, when one middle conducting bracket (20C) is disposed between the side conducting bracket (10) and is connected to the side conducting brackets (10) to form a series circuit, the coil has four loops.

The coil of the transformer as described has the following advantages. The side conducting brackets (10) and the at least one middle conducting bracket (20A, 20B, 20C) of some specific type are connected to form different numbers of loops or different types of circuits (series circuits or parallel circuits). Therefore, designing and fabricating the coil are flexible and materials and manufacturing costs are saved. Moreover, the side conducting brackets (10) and the at least one middle conducting bracket (20A, 20B, 20C) require only two soldered joints when connected to form a series circuit or four soldered joints when connected to form a parallel circuit. Thus, number of the soldered joints required is limited so efficiency of the transformer is improved.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A coil of a transformer comprising:
two side conducting brackets disposed opposite to each other, and each side conducting bracket having a ring having
two ends;
an opening defined between the ends of the ring of the side conducting bracket;
a first and a second terminals respectively extended outwardly from the ends of the ring of the side conducting bracket and the first terminal of one side conducting bracket aligning with the second terminal of the other side conducting bracket; and
at least one middle conducting bracket disposed between the side conducting brackets and each of the at least one middle conducting bracket having a first terminal and a second terminal respectively connected to the first and second extensions of the side conducting brackets.

2. The coil as claimed in claim 1, wherein
each of the at least one middle conducting bracket is elongated and has two ends;
the first terminal of each of the at least one middle conducting bracket is formed on one end of the at least one middle conducting bracket and protrudes toward one side of the at least one middle conducting bracket; and
the second terminal of each of the at least one middle conducting bracket is formed on the other end of the at least one middle conducting bracket and protrudes toward two opposite sides of the at least one middle conducting to bracket.

3. The coil as claimed in claim 1, wherein
each of the at least one middle conducting bracket is spiral-shaped and has at least one ring, and each of the at least one ring has two ends; and
the first and second terminals of each of the at least one middle conducting bracket are respectively formed on and protrude from the ends of the at least one ring of the at least one middle conducting bracket.

4. The coil as claimed in claim 3, wherein
each of the at least one middle conducting bracket has one ring having an opening defined between the ends of the ring of the at least one middle conducting bracket; and
the first and second terminals of each of the at least one middle conducting bracket are respectively formed on and protrude from the ends of the ring of the at least one middle bracket.

5. The coil as claimed in claim 3, wherein
each of the at least one middle conducting bracket has multiple rings, and each ring of each of the at least one middle conducting bracket has
an opening defined between the ends of the ring of the at least one middle conducting bracket;
a first extension; and;
a second extension attached to the first extension of an adjacent ring of the at least one middle conducting bracket;
the first terminal of each of the at least one middle conducting bracket is formed on and protrudes from the first extension of the ring that is arranged in an end of the at least one middle conducting bracket; and
the second terminal of each of the at least one middle conducting bracket is formed on and protrudes from the second extension of the ring that is arranged in another end of the at least one middle conducting bracket.

6. The coil as claimed in claim 1, wherein each side conducting bracket further has a base panel extended from the first terminal of the ring of the side conducting bracket and having at least one pin formed on a peripheral edge of the base panel.

7. The coil as claimed in claim 2, wherein each side conducting bracket further has a base panel extended from the first terminal of the ring of the side conducting bracket and having at least one pin formed on a peripheral edge of the base panel.

8. The coil as claimed in claim 3, wherein each side conducting bracket further has a base panel extended from the first terminal of the ring of the side conducting bracket and having at least one pin formed on a peripheral edge of the base panel.

9. The coil as claimed in claim 4, wherein each side conducting bracket further has a base panel extended from the first terminal of the ring of the side conducting bracket and having at least one pin formed on a peripheral edge of the base panel.

10. The coil as claimed in claim 5, wherein each side conducting bracket further has a base panel extended from the first terminal of the ring of the side conducting bracket and having at least one pin formed on a peripheral edge of the base panel.

11. The coil as claimed in claim 1 having one middle conducting bracket disposed between the side conducting brackets, wherein the first and second terminals of the middle conducting bracket are respectively connected to the second terminals of the side conducting brackets.

12. The coil as claimed in claim 2 having one middle conducting bracket disposed between the side conducting brackets, wherein the first and second terminals of the middle conducting bracket are respectively connected to the second terminals of the side conducting brackets.

13. The coil as claimed in claim 3 having one middle conducting bracket disposed between the side conducting brackets, wherein the first and second terminals of the middle conducting bracket are respectively connected to the second terminals of the side conducting brackets.

14. The coil as claimed in claim 4 having one middle conducting bracket disposed between the side conducting brackets, wherein the first and second terminals of the middle conducting bracket are respectively connected to the second terminals of the side conducting brackets.

15. The coil as claimed in claim 5 having one middle conducting bracket disposed between the side conducting brackets, wherein the first and second terminals of the middle conducting bracket are respectively connected to the second terminals of the side conducting brackets.

16. The coil as claimed in claim 1 having two middle conducting brackets disposed between the side conducting brackets, wherein
the first terminals of the middle conducting brackets are respectively connected to the first terminals of the side conducting brackets; and
the second terminals of the middle conducting brackets are respectively connected to the second terminals of the side conducting brackets.

17. The coil as claimed in claim 2 having two middle conducting brackets disposed between the side conducting brackets, wherein
the first terminals of the middle conducting brackets are respectively connected to the first terminals of the side conducting brackets; and
the second terminals of the middle conducting brackets are respectively connected to the second terminals of the side conducting brackets.

18. The coil as claimed in claim 3 having two middle conducting brackets disposed between the side conducting brackets, wherein
the first terminals of the middle conducting brackets are respectively connected to the first terminals of the side conducting brackets; and
the second terminals of the middle conducting brackets are respectively connected to the second terminals of the side conducting brackets.

19. The coil as claimed in claim 4 having two middle conducting brackets disposed between the side conducting brackets, wherein
the first terminals of the middle conducting brackets are respectively connected to the first terminals of the side conducting brackets; and
the second terminals of the middle conducting brackets are respectively connected to the second terminals of the side conducting brackets.

20. The coil as claimed in claim 5 having two middle conducting brackets disposed between the side conducting brackets, wherein
the first terminals of the middle conducting brackets are respectively connected to the first terminals of the side conducting brackets; and
the second terminals of the middle conducting brackets are respectively connected to the second terminals of the side conducting brackets.
